(19) United States
(12) Patent Application Publication
(10) Pub. No.: US 2016/0023503 A1
(43) Pub. Date: Jan. 28, 2016

(54) CONCAVE-CONVEX PATTERN TRANSFER MATERIAL

(71) Applicant: AICELLO CORPORATION, Aichi (JP)

(72) Inventor: Shigenori SAITO, Toyohashi-shi (JP)

(21) Appl. No.: 14/415,708

(22) PCT Filed: Sep. 22, 2014
(86) PCT No.: PCT/JP2014/075090

§ 371 Date: Jan. 19, 2015

(30) Foreign Application Priority Data
Feb. 7, 2014 (JP) 2014-022652

(51) Int. Cl. B44C 1/175; B44C 1/22

(52) U.S. Cl. CPC B44C 1/1758; B44C 1/227; B44C 1/1754

(57) ABSTRACT

Forming a film by means of water-pressure transfer is subject to wrinkling and other problems. Accordingly, provided is a pressurization transfer film constituted by a support layer, water-soluble resin layer, and ink layer stacked on top of each other in this order, wherein a concave-convex surface is formed on the ink layer side of the water-soluble resin layer.

### TECHNICAL FIELD

The present invention relates to a material for transferring a concave-convex pattern onto the surface of a target, as well as a transfer method.

### BACKGROUND ART

It is known that a water-pressure transfer film whose base film is made of a water-soluble film can be used, according to the water-pressure transfer method, to form a concave-convex pattern on the surface of a target (Patent Literatures 1 and 2).

Patent Literatures 1 and 2 describe how a film constituted by a water-soluble film, a transfer adjustment layer present on top of the water-soluble film and exhibiting water swelling property and water solubility while having a concave-convex surface, and a thin metal layer present on top of the concave-convex surface of the transfer adjustment layer, is provided as a water-pressure transfer film and this film is used to form a thin metal layer of the concave-convex surface on a transfer target.

In addition, Patent Literature 3 describes how a protective layer transfer sheet is prepared whose surface has fine concaves and convexes and which has a protective layer, concave-convex layer, and heat seal layer, in this order, on a base material sheet to add semi-glossy feel, and a transfer target is overlaid with the protective layer transfer sheet in such a way that the transfer target adheres tightly to the heat seal layer, after which only the base material sheet is peeled off, in order to provide a concave-convex layer on the transfer target whose topmost layer is the protective layer.

Furthermore, Patent Literature 4 described a method whereby a tape constituted by a peeling tape layer, water-soluble adhesive layer, recording tape layer made of water-soluble polyvinyl alcohol, and printing layer printed with water-insoluble ink, is treated in water to remove the adhesive layer and recording tape layer corresponding to a non-printed part. Next, a separate application sheet having weak adhesive property is attached onto the printing layer of the tape now constituted by the adhesive layer, recording tape layer, and peeling tape layer corresponding to a printed part, and the tape is tentatively held in this condition.

The peeling tape layer is peeled off from this tape being held, and then the printed part having the recording tape layer, adhesive layer, and printing layer is attached to the surface of an attaching target in such a way that the application sheet becomes the topmost layer, after which the application sheet is peeled off to cause the printing layer to attach to the surface of the attaching target via the adhesive layer and recording tape layer.

### BACKGROUND ART LITERATURE

### Patent Literatures

Patent Literature 1: Japanese Patent Laid-open No. 2013-895

Patent Literature 2: Japanese Patent Laid-open No. 2013-897

Patent Literature 3: Japanese Patent Laid-open No. 2011-865

Patent Literature 4: Japanese Patent Laid-open No. 2001-146097

### SUMMARY OF THE INVENTION

### Problems to Be Solved by the Invention

Transferring a pattern or other film onto a transfer target according to the water-pressure transfer method provides an excellent way to ensure proper transfer even when the transfer target has a complex three-dimensional shape; however, the water-pressure transfer method requires a step to float the film on water and therefore it is difficult to form the pattern on the transfer target at an accurate position. In addition, lack of sufficient control of transfer conditions can lead to wrinkling or other problems of the film caused by the water pressure, pressure generated from soaking the transfer target, and the like.

If the film has no concaves and convexes on the surface, its wrinkling can be prevented to some extent at the time of transfer; if the film has concaves and convexes, on the other hand, such wrinkling or other problems easily occur.

Additionally, unlike the water-pressure transfer method, the concave-convex layer transfer method that uses a protective layer transfer sheet which is constituted by a base material sheet and a protective layer, concave-convex layer, and heat seal layer present on top in this order, can make the concave-convex layer pattern less conspicuous due to the thickness of the protective layer or heat seal layer or because the concaves and convexes of the concave-convex layer must be reflected onto the protective layer surface.

The method to use a tape constituted by a peeling tape layer, water-soluble adhesive layer, and recording tape layer made of water-soluble polyvinyl alcohol and printing layer printed with water-insoluble ink not only makes the layer structure of the tape complex, but it also makes the attaching step complex by requiring an application sheet in the attaching step, thus resulting in poor operability in terms of pattern forming.

### Means for Solving the Problems

After studying in earnest to solve the aforementioned problems, the inventor of the present invention found that they could be solved by the means described below and consequently completed the present invention:
1. A pressurization transfer film constituted by a support layer, water-soluble resin layer, and ink layer stacked on top of each other in this order, wherein the average roughness Ra of the water-soluble resin layer side of the support layer is 0.30 μm or less and a concave-convex surface is formed on the ink layer side of the water-soluble resin layer.
2. A pressurization transfer film according to 1, constituted by a support layer, water-soluble resin layer, and ink layer stacked on top of each other in this order, wherein the average roughness Ra of the water-soluble resin layer side of the support layer is 0.30 μm or less and a concave-convex surface is formed on the ink layer.
3. A pressurization transfer film according to 1 or 2, wherein an adhesive layer is further formed on the side of the ink layer opposite the water-soluble resin layer side.
4. A pressurization transfer film according to any one of 1 to 3, wherein the water-soluble resin that constitutes the water-soluble resin layer is made of one or more types of resins selected from the group that includes saponified polyvinyl acetates and copolymers thereof, aqueous acrylic resins, aqueous polyester resins, polyoxy ethylene, and polystyrene sulfonates.
5. A pressurization transfer film according to any one of 1 to 4, wherein the support layer has a rate of change in dimension of 0 to 3% in both longitudinal direction and lateral direction in an environment of 4.00 g/m³ to 40.9 g/m³ in humidity range.
6. A pressurization transfer film according to any one of 1 to 5, wherein the ink layer provided on the concave-convex surface of the water-soluble resin layer is filled in the concaves of the concave-convex surface, while the convexes have no ink layer formed on them.
7. A method for forming a concave-convex pattern on the surface of a transfer target according to steps a to d below:
a. A step to attach to the transfer target surface a pressurization transfer film according to any one of 1 to 6 so that its support layer side is positioned on the exterior surface;
b. A step to apply pressure to the film attached in step a from its support layer side;
c. A step to peel off the support layer from the water-soluble resin layer; and
d. A step to supply water to the exposed water-soluble resin layer and thereby dissolve the water-soluble resin layer to remove the water-soluble resin layer from the ink layer, in order to form an ink layer having concaves and convexes formed on its surface.
8. A transfer target etching method whereby a pressurization transfer film according to 6 is used to partially provide an ink layer on the surface of a transfer target made of metal, after which the exposed metal part of the transfer target surface is decomposed to etch the metal surface.

### Effects of the Invention

According to the pressurization transfer film proposed by the present invention, there is no need to adopt the water-pressure transfer method for transferring it onto the transfer target and therefore the ink layer can be adhered tightly to the transfer target surface under a dry condition. This means that, when concaves and convexes are formed on the transfer target surface, an ink layer having a stable concave-convex surface can be formed on the transfer target without causing the ink layer to wrinkle.

In addition, since the support layer is peeled off after the pressurization transfer film according to the present invention has adhered tightly to the transfer target surface, the tight adhesion step can adopt a very elastic film as the support layer to be adhered to the transfer target surface under sufficient pressurization, in order to ensure a stable operation. This, too, prevents the wrinkling of the surface of the concave-convex layer thus formed or breaking of patterns such as text.

Once the pressurization transfer film has adhered tightly to the transfer target surface and the support layer has been peeled off, the water-soluble resin concave-convex layer can be dissolved/removed by pouring water over the film or soaking it in a water bath, etc., to form a concave-convex ink layer on the transfer target surface without applying any force to the ink layer, and this step also protects the concave-convex ink layer against damage.

In addition, by filling the ink layer only in the concaves among the concaves and convexes on the surface of the water-soluble resin layer and keeping the convexes free from the ink layer, the ink layer formed on the transfer target as a result of pressurization transfer will only cover the areas corresponding to the concaves but not the areas corresponding to the convexes.

If the transfer target is made of metal, an etching step can be adopted subsequently to etch only the surface where the ink layer is not formed, thereby allowing an etching pattern to be formed on the metal transfer target surface by this simple method.

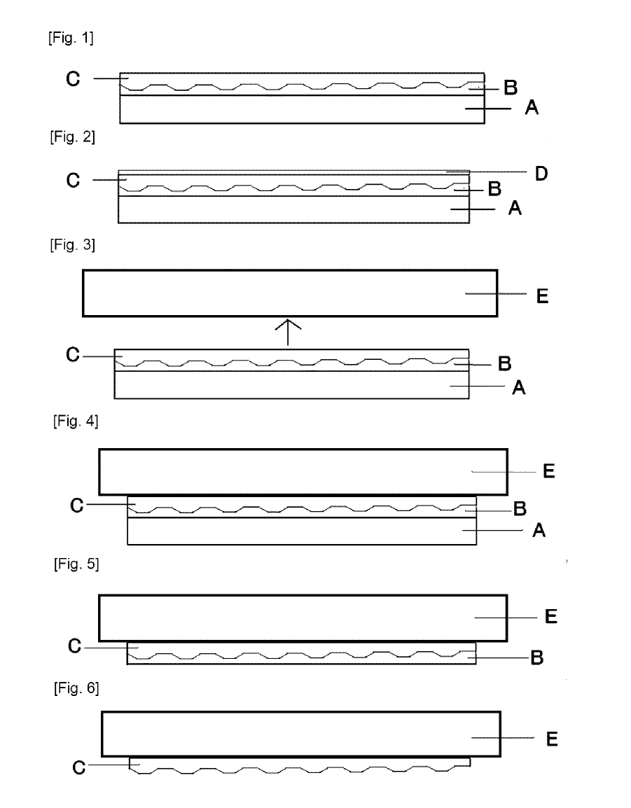

### BRIEF DESCRIPTION OF THE DRAWINGS

[FIG. 1] Pressurization transfer film according to the present invention

[FIG. 2] Pressurization transfer film according to the present invention, which has an adhesive layer D

[FIG. 3] Transfer target constituted by the pressurization transfer film attached on it

[FIG. 4] Pressurization transfer film fixed onto the transfer target

[FIG. 5] Exposed concave-convex layer of water-soluble resin

[FIG. 6] Transfer target with an ink layer on which concaves and convexes are formed

### MODE FOR CARRYING OUT THE INVENTION

Favorable modes for carrying out the present invention are explained in detail below, but the present invention is not limited in its scope to these modes.

The pressurization transfer film proposed by the present invention is aimed at reliably forming a concave-convex surface on a transfer target surface, and to this end it is basically structured by a support layer, water-soluble resin layer, and ink layer stacked on top of each other in this order.

The pressurization transfer film proposed by the present invention, and the pressurization transfer method using the film, are described below.

### <Pressurization Transfer Film>

### (Support Layer)

Any support layer that can be used in the pressurization transfer film proposed by the present invention is a layer capable of holding the ink layer via the water-soluble resin layer while being peelable from the water-soluble resin layer in the pressurization transfer step, so that the ink layer can be adhered tightly to the transfer target surface accurately and without wrinkling.

Additionally, to ensure sufficient ease of handling the water-soluble resin layer and the ink layer on top, the film must have appropriate strength to make it easy to hold the film with a hand, jig, etc., as well as appropriate thickness to achieve such strength.

The material for such support layer is not limited in any way and may be metal, glass, resin, paper, etc.: for example, a film made of metal such as aluminum, iron, copper or the like; a film made of any of various resins including polyolefin such as polyethylene, polypropylene or the like, polyester such as PET or the like, acrylic resin such as polyimide, polyamide, polyurethane, polyacrylate methyl or the like, elastomer such as natural rubber, styrene-butadiene rubber or the like; or paper such as coated paper or the like.

To ensure excellent dimensional stability during storage, the pressurization transfer film proposed by the present invention must have a rate of change in dimension of 0 to 3%, or preferably 0 to 1.5%, or more preferably 0%, in both longitudinal direction and lateral direction in an environment of 4.00 g/m³ to 40.9 g/m³, or preferably 4.00 g/cm³ to 16.5 g/cm³, in humidity range. When the rate of change in dimension is 0%, as mentioned above, it means that dimensional change does not occur even when the humidity changes within the applicable humidity range.

Under the present invention, keeping the rate of change in dimension of the support to these ranges allows the pressurization transfer film proposed by the present invention, as a whole, to maintain sufficient dimensional stability.

Additionally, if dimensional change occurs in an environment where the humidity is below 4.00 g/m³, the pressurization transfer film proposed by the present invention will undergo dimensional change while the film is in storage, potentially causing the concave-convex pattern to wrinkle or preventing the planned concaves and convexes from being formed on the transfer target.

On the other hand, an environment where the humidity exceeds 16.5 g/m³ is a humidity environment that rarely occurs so long as normal care is exercised during storage.

So as to ensure shape stability of the concave-convex pattern on the water-soluble resin layer, the pressurization transfer film proposed by the present invention must have an average surface roughness Ra of 0.30 μm or less, or preferably 0.15 μm or less, or more preferably 0.10 μm or less, on the water-soluble resin layer side of the support layer. Under the present invention, keeping the average surface roughness Ra within these ranges allows the shape of the concave-convex pattern to be maintained. If the average surface roughness Ra exceeds 0.30 μm, the surface roughness may affect the concave-convex shape, particularly when the concave-convex pattern is fine.

Other properties required of the support layer include adhering, with an appropriate adhesive force, to the water-soluble resin layer formed on its surface, and easily peeling from the water-soluble resin layer after the ink layer has been adhered tightly to the transfer target.

To this end, fine concaves and convexes may be formed on the side of the support layer on which the water-soluble resin layer is formed, or corona discharge treatment may be given, or a primer layer may be formed, as necessary, to improve the adhesive force.

In addition, a release agent layer constituted by a silicone compound or long-chain alkyl group-containing compound may be provided on the side of the support layer on which the concave-convex layer of water-soluble resin is formed, so that the support layer can be peeled from the water-soluble resin layer with ease.

Furthermore, a protective layer constituted by an acrylic compound or urethane compound may be provided on the side on which concaves and convexes of water-soluble resin are formed, in order to protect the ink layer after the pressurization transfer.

### (Water-Soluble Resin Layer)

The resin that forms the water-soluble resin layer must have sufficient adhesion property with respect to the ink layer formed on its concave-convex surface, and desirably the resin also dissolves quickly in water after the support layer has been peeled off.

The water-soluble resin for forming the water-soluble resin layer used under the present invention may be any known water-soluble resin, but it is particularly preferable to use one or more types of resins selected from the group that includes saponified polyvinyl acetates and copolymers thereof, aqueous acrylic resins, aqueous polyester resins, polyoxy ethylene, and polystyrene sulfonates.

By adopting any of these water-soluble resins, a concave-convex pattern can be formed on the surface of the layer made of this water-soluble resin and this pattern can be maintained, and also because the resin has sufficient adhesion property with respect to the ink layer provided on top, a pressurization transfer film offering excellent storageability can be obtained.

As for the means for forming the water-soluble resin layer, a water-soluble resin solution can be applied onto the support layer surface by means of solution casting, etc., or a separately formed water-soluble resin sheet can be laminated, etc.

Once a water-soluble resin layer has been formed on the support layer surface by a given method, a die, etc., on which concaves and convexes are formed may be pressed onto the surface of the water-soluble resin layer or the water-soluble resin surface may be ground or any other known method for forming concaves and convexes may be used to transfer the concave-convex shape, thereby forming a concave-convex pattern on the surface of the water-soluble resin layer.

Any concave-convex pattern may be formed, and a wave pattern, text, graphics, etc., can be selected as necessary. Even a pattern with text, lines, or other detailed parts can be formed on the surface of the water-soluble resin layer inside the area where pattern forming is possible.

### (Ink Layer)

The ink layer used under the present invention is formed on the surface of the water-soluble resin layer by printing or application. It can be obtained from an ink composition that has sufficient adhesive force with respect to the water-soluble resin layer and can stably maintain a concave-convex surface after the transfer onto the transfer target. The ink layer may be formed over the entire surface of the pressurization transfer film or in some areas. If the ink layer is formed in some areas, the transfer target surface will be exposed in the areas where the ink layer is not formed once the water-soluble resin is subsequently removed. It is also possible to form a concave-convex pattern on the ink layer itself by means of printing, application, concave-convex plate, etc.

When the ink layer is formed in some areas, it may be formed on one half of the surface of the pressurization transfer film, or the ink layer may be formed in such a way that only the concaves among the concaves and convexes formed on the surface of the water-soluble resin are filled, while no ink layer is provided on the surface of the convexes among the concaves and convexes.

The composition for forming the ink layer is one that contains a resin, coloring agent, and/or any of various additives, etc., and for the resin, coloring agent, and any of various additives, etc., used, any material used in a known ink composition may be adopted. The ink composition must have appropriate viscosity or fluidity that allows it to be reliably filled in the concaves once printed or applied onto the surface of the water-soluble resin layer.

However, the ink composition forms an ink layer on the surface of the water-soluble resin layer, and therefore selecting an aqueous ink composition is not appropriate because the water-soluble resin layer will be dissolved. Accordingly, the ink composition must use a non-aqueous organic solvent.

### (Adhesive Layer)

The adhesive layer, which is used as necessary under the present invention, is intended to fix the transfer target and ink layer with a stronger adhesive force, and is formed on the surface of the ink layer.

The adhesive layer may be a layer constituted by an adhesive, in which case when the ink layer side of the pressurization transfer film proposed by the present invention is adhered tightly to the transfer target surface, the pressurization transfer film can be reliably fixed onto the transfer target by means of the adhesive force of the adhesive, thereby making it easier to handle the tightly adhered transfer target and pressurization transfer film.

Also, when the support layer is peeled off, the support can be peeled off with the transfer target fixed in position, which increases the reliability and ease of peeling. For this adhesive layer, acrylic resin, elastomer, or any known adhesive can be adopted.

The adhesive layer can also be formed from any known thermosetting adhesive, energy ray-curable adhesive, etc. If any such adhesive is adopted, the pressurization transfer film proposed by the present invention is fixed on the transfer target surface, and then heat is applied or energy ray is irradiated to cure the adhesive layer before or after peeling the support layer.

### (Other Structure)

The pressurization transfer film proposed by the present invention permits its ink layer or adhesive layer surface to be covered with a cover film to prevent deterioration or soiling of the film during storage. Needless to say, the cover film must be easily peelable from the surface of the ink layer or adhesive layer, and it normally remains on until immediately before the pressurization transfer film is used.

### <Method for Forming Concave-Convex Pattern on Transfer Target Surface>

The method for forming a concave-convex pattern on the transfer target surface by adopting the pressurization transfer film proposed by the present invention basically comprises steps a to d below, and is not at least the so-called water-pressure transfer method.

Under this method, the concave-convex ink layer adheres tightly to the transfer target surface as a result of pressurization from the support layer side, which allows for adjustment of how a force is applied at the time of pressurization to achieve positioning or tight adhesion, and consequently the desired concave-convex pattern can be formed without fail.
a. A step to attach the pressurization transfer film to the transfer target surface so that its support layer side is positioned on the exterior surface.
b. A step to apply pressure to the film attached in step a from its support layer side.
c. A step to peel off the support layer from the water-soluble resin layer.
d. A step to supply water to the exposed water-soluble resin layer and thereby dissolve the water-soluble resin layer to remove the water-soluble resin layer from the ink layer.

If a curable adhesive layer is formed on the pressurization transfer film, a step to cure the curable adhesive layer can be added in any of these steps.

### (Step to Attach Pressurization Transfer Film to Transfer Target Surface)

Prior to the step to attach the pressurization transfer film to the transfer target surface under the present invention, the transfer target is prepared, and a cover film provided as necessary on the surface of the ink layer or adhesive layer of the pressurization transfer film is peeled off. The pressurization transfer film upon the peeling is shown in FIG. 1. A indicates the support layer, B indicates the water-soluble resin layer, and C indicates the ink layer. FIG. 2 shows another example where there is also an adhesive layer D.

The surface of the ink layer or adhesive layer of the pressurization transfer film is positioned with respect to the transfer part of the transfer target, and then the film is attached.

(Step to Apply Pressure from Support Layer Side and/or Pressurization Transfer Film Side)

As shown in FIG. 3, the transfer target E to which the pressurization transfer film has been attached is fixed in position using a hand, jig, etc., while pressure is applied from the support layer side, so that the pressurization transfer film and transfer target are more securely fixed to each other, as shown in FIG. 4.

At this time, care must be exercised so as not to let the pressurization transfer film shift with respect to the transfer target surface.

(Step to Peel Off Support Layer from Water-soluble Resin Layer)

Only the support is peeled off from the transfer target and pressurization transfer film that have been securely fixed to each other in the above step, to expose the water-soluble resin layer on the surface, as shown in FIG. 5.

In this peeling step, too, care must be exercised not to let the pressurization transfer film shift, and also to prevent the adhesive layer or ink layer from peeling off from the transfer target due to the peeling force.

### (Step to Remove Water-soluble Resin Layer)

After the support layer has been peeled off in the above step, the surface of the water-soluble resin layer is caused to come in contact with water to remove the exposed water-soluble resin layer.

This contact with water is achieved by spraying or solution casting water onto the surface of the water-soluble resin layer, or soaking in a water bath at least the part of the transfer target where the surface of the water-soluble resin layer is exposed, or by adopting any other means.

As a result of the above, the water-soluble resin is dissolved in water, thereby removing the water-soluble resin from the transfer target surface and exposing the ink layer on which concaves and convexes are formed, as shown in FIG. 6.

Thereafter, the transfer target surface is washed and then adhesive water is dried and removed, as necessary, to obtain a transfer target having the desired concave-convex pattern.

The pressurization transfer film proposed by the present invention can be used not only to simply forming an ink layer with concaves and convexes on the transfer target surface, but this can also be applied to form a concave-convex pattern on the surface of a transfer target made of metal.

To be specific, a pressurization transfer film according to the present invention, which has an ink layer partially provided on it, is used to partially provide an ink layer on the surface of the metal transfer target beforehand according to the aforementioned method, while exposing the metal surface in other areas having no ink layer.

Alternately on a pressurization transfer film according to the present invention, ink is filled beforehand only in the concaves among the concaves and convexes provided on the surface of the water-soluble resin layer, while keeping the surface of the convexes free from the ink layer. By using the pressurization transfer film and according to the aforementioned method, ink-layer convexes alone are provided on the surface of the metal transfer target beforehand, while exposing the metal surface in non-convex areas.

On the transfer target with its metal partially exposed on the surface, as has been formed by one of these methods, any of various known etching means is used to form concaves on the exposed metal surface. Thereafter, the ink layer can be removed from the transfer target surface to form concaves and convexes on the transfer target surface.

### EXAMPLES

The present invention is explained in greater detail below using examples.

It should be noted that each of these examples represents only one embodiment of the invention and the present invention is not limited by these examples.

### Example 1

### <Transfer Film>

Using as a support layer a polyethylene terephthalate (PET) film (by Unitika) with a thickness of 75 μm and average roughness Ra of 0.06 μm, 90% saponified polyvinyl acetate (JP-18 by Japan VAM & POVAL) was applied to a dry thickness of 30 μm using a bar coater to form a water-soluble resin layer on the support layer.

Next, a hydraulic press (by Shinto Metal Industries) with concave-convex pattern dies was used to pressurize the water-soluble resin layer under heat, to obtain a concave-convex layer of water-soluble resin with the 10-point average roughness Rz shown in Table 1.

Next, nitrocellulose ink was applied with a bar coater on the concave-convex layer of water-soluble resin to obtain an ink layer of 5 g/m².

Next, acrylic resin adhesive was applied with a bar coater on the ink layer to obtain an adhesive layer of 2 g/m².

### <Transfer>

On a transfer target which is a polycarbonate plate with a 150×150 mm square drawn on it using an oil-based black marker, the acrylic resin adhesive layer side of the transfer sheet cut to a size of 150×150 mm was placed so that it fit the surface inside the square, after which pressure was applied to attach the two.

Next, only the support layer was peeled off and the polycarbonate plate was soaked in a water bath to remove the water-soluble resin layer by supersonic washing, whereby the ink layer was transferred onto the surface of the polycarbonate plate via the acrylic resin adhesive.

### Example 2 and Example 3

### <Transfer Film>

A transfer film was obtained under the same conditions as in Example 1, except that the concave-convex layer of water-soluble resin had the value shown in Table 1.

### <Transfer>

Transfer was made under the same conditions as in Example 1.

### Comparative Example 1

### <Transfer Film>

A transfer film was obtained under the same conditions as in Example 1, except that a matte polyester film (by Unitika) with a support layer of 0.35 μm in average roughness Ra was used.

### <Transfer>

Transfer was made under the same conditions as in Example 1.

### Comparative Example 2

### <Transfer Film>

A transfer film was obtained under the same conditions as in Example 1.

### <Water-pressure Transfer>

The support layer of the transfer film cut to a size of 150×150 mm was peeled off and the transfer film was floated in a water bath so that the side of the concave-convex layer of water-soluble resin contacted water. Next, after the water-soluble resin layer has swollen and dissolved, the transfer target, or specifically the polycarbonate plate with a 150×150 mm square drawn on it using an oil-based black marker, was pressed from the adhesive layer side to transfer the ink layer.

In other words, the ink layer was transferred based on water-surface transfer, not based on pressurization transfer, in this Comparative Example 2.

### <Performance Evaluation Test>

The results of comparing the various properties of the transfer products made by the transfer films in Examples 1 to 3 and Comparative Examples 1 and 2 are shown in Table 1.

### <Test Method>

1. Average roughness Ra

Measured on the water-soluble resin layer side of the support layer according to a method conforming to the JIS B 0601 standard.
2. 10-point average roughness Rz

Measured on the ink layer side of the water-soluble resin layer according to a method conforming to the JIS B 0601 standard.
3. Alignment

As for alignment, whether or not the transfer film cut to a size of 150×150 mm can be transferred into the 150×150 mm square drawn on the polycarbonate plate with an oil-based marker was visually observed.

◯: The cutout film could be transferred into the square.

×: The cutout film protruded from the square.
4. Wrinkling

Whether or not the ink layer transferred onto the polycarbonate plate was wrinkled was visually observed.

◯: The layer could be transferred without wrinkling.

×: The layer was wrinkled when transferred.
5. Concave-convex pattern of ink layer after transfer

Whether or not the concave-convex pattern shape was maintained after the ink layer had been transferred onto the polycarbonate plate was visually observed.

◯: The concave-convex pattern shape was maintained.

×: The concave-convex pattern shape was distorted.

TABLE 1

| | 10-point average roughness | | | Concave-convex |
|---|---|---|---|---|
| | Rz of concave-convex | | | pattern of ink layer |
| | layer of water-soluble resin | Alignment | Wrinkling | after transfer |
| Example 1 | 0.7 μm | ◯ | ◯ | ◯ |
| Example 2 | 2.0 μm | ◯ | ◯ | ◯ |
| Example 3 | 4.5 μm | ◯ | ◯ | ◯ |
| Comparative | 0.7 μm | ◯ | ◯ | X |
| Example 1 | | | | |
| Comparative | 0.7 μm | X | X | X |
| Example 2 | | | | |

It was confirmed that, when concave-convex patterns are formed on the transfer target surface, the concave-convex pattern transfer material proposed by the present invention could form, on a transfer target, an ink layer having a stable concave-convex pattern shape without wrinkling the ink layer.

Particularly as opposed to Comparative Example 1 where a support with a surface roughness Ra exceeding the value conforming to the present invention was used, the present invention, such as the one in Example 1, demonstrates the effect of forming a distortion-free concave-convex shape on the ink layer surface after the transfer even when the ink layer side of the water-soluble resin layer has the same Rz value.

### INDUSTRIAL FIELD OF APPLICATION

The concave-convex pattern transfer material proposed by the present invention can provide a method for forming, on a transfer target, an ink layer having a stable concave-convex pattern shape. The obtained ink layer having a concave-convex pattern can be utilized for metal surface treatment process films as well as film members for various patterning processes such as automobile coating, resist patterning, and wire patterning.

1. A pressurization transfer film constituted by a support layer, a water-soluble resin layer, and an ink layer stacked on top of each other in this order, wherein an average roughness Ra of a water-soluble resin layer side of the support layer is 0.30 μm or less; and a concave-convex surface is formed on an ink layer side of the water-soluble resin layer; and also a concave-convex surface is formed on the ink layer.

2. (canceled)

3. A pressurization transfer film according to claim 1, wherein an adhesive layer is further formed on a side of the ink layer opposite the water-soluble resin layer side.

4. A pressurization transfer film according to claim 1, wherein a water-soluble resin that constitutes the water-soluble resin layer is made of one or more types of resins selected from a group that includes saponified polyvinyl acetates and copolymers thereof, aqueous acrylic resins, aqueous polyester resins, polyoxy ethylene, and polystyrene sulfonates.

5. A pressurization transfer film according to claim 1, wherein the support layer has a rate of change in dimension of 0 to 3% in both longitudinal direction and lateral direction in an environment of 4.00 g/m³ to 40.9 g/m³ in humidity range.

6. A pressurization transfer film according to claim 1, wherein the ink layer provided on the concave-convex surface of the water-soluble resin layer is filled in concaves of the concave-convex surface, while convexes have no ink layer formed on them.

7. A method for forming a concave-convex pattern on a surface of a transfer target according to steps a to d below:
a. A step to attach to a transfer target surface a pressurization transfer film according to claim 1 so that its support layer side is positioned on an exterior surface;
b. A step to apply pressure to the film attached in step a from its support layer side;
c. A step to peel off the support layer from a water-soluble resin layer; and
d. A step to supply water to an exposed water-soluble resin layer and thereby dissolve the water-soluble resin layer to remove the water-soluble resin layer from the ink layer, in order to form an ink layer having concaves and convexes formed on its surface.

8. A transfer target etching method whereby a pressurization transfer film according to claim 6 is used to partially provide an ink layer on a surface of a transfer target made of metal, after which an exposed metal part of the transfer target surface is decomposed to etch a metal surface.

9. A pressurization transfer film according to claim 3, wherein a water-soluble resin that constitutes the water-soluble resin layer is made of one or more types of resins selected from a group that includes saponified polyvinyl acetates and copolymers thereof, aqueous acrylic resins, aqueous polyester resins, polyoxy ethylene, and polystyrene sulfonates.

10. A pressurization transfer film according to claim 3, wherein the support layer has a rate of change in dimension of 0 to 3% in both longitudinal direction and lateral direction in an environment of 4.00 g/m³ to 40.9 g/m³ in humidity range.

11. A pressurization transfer film according to claim 4, wherein the support layer has a rate of change in dimension of 0 to 3% in both longitudinal direction and lateral direction in an environment of 4.00 g/m³ to 40.9 g/m³ in humidity range.

12. A pressurization transfer film according to claim 3, wherein the ink layer provided on the concave-convex surface of the water-soluble resin layer is filled in concaves of the concave-convex surface, while convexes have no ink layer formed on them.

13. A pressurization transfer film according to claim 4, wherein the ink layer provided on the concave-convex surface of the water-soluble resin layer is filled in concaves of the concave-convex surface, while convexes have no ink layer formed on them.

14. A pressurization transfer film according to claim 5, wherein the ink layer provided on the concave-convex surface of the water-soluble resin layer is filled in concaves of the concave-convex surface, while convexes have no ink layer formed on them.

15. A method for forming a concave-convex pattern on a surface of a transfer target according to steps a to d below:
a. A step to attach to a transfer target surface a pressurization transfer film according to claim 3 so that its support layer side is positioned on an exterior surface;
b. A step to apply pressure to the film attached in step a from its support layer side;
c. A step to peel off the support layer from a water-soluble resin layer; and
d. A step to supply water to an exposed water-soluble resin layer and thereby dissolve the water-soluble resin layer to remove the water-soluble resin layer from the ink layer, in order to form an ink layer having concaves and convexes formed on its surface.

16. A method for forming a concave-convex pattern on a surface of a transfer target according to steps a to d below:
a. A step to attach to a transfer target surface a pressurization transfer film according to claim 4 so that its support layer side is positioned on an exterior surface;
b. A step to apply pressure to the film attached in step a from its support layer side;
c. A step to peel off the support layer from a water-soluble resin layer; and
d. A step to supply water to an exposed water-soluble resin layer and thereby dissolve the water-soluble resin layer to remove the water-soluble resin layer from the ink layer, in order to form an ink layer having concaves and convexes formed on its surface.

17. A method for forming a concave-convex pattern on a surface of a transfer target according to steps a to d below:
a. A step to attach to a transfer target surface a pressurization transfer film according to claim 5 so that its support layer side is positioned on an exterior surface;
b. A step to apply pressure to the film attached in step a from its support layer side;
c. A step to peel off the support layer from a water-soluble resin layer; and
d. A step to supply water to an exposed water-soluble resin layer and thereby dissolve the water-soluble resin layer to remove the water-soluble resin layer from the ink layer, in order to form an ink layer having concaves and convexes formed on its surface.

18. A method for forming a concave-convex pattern on a surface of a transfer target according to steps a to d below:
a. A step to attach to a transfer target surface a pressurization transfer film according to claim 6 so that its support layer side is positioned on an exterior surface;
b. A step to apply pressure to the film attached in step a from its support layer side;
c. A step to peel off the support layer from a water-soluble resin layer; and
d. A step to supply water to an exposed water-soluble resin layer and thereby dissolve the water-soluble resin layer to remove the water-soluble resin layer from the ink layer, in order to form an ink layer having concaves and convexes formed on its surface.

19. A transfer target etching method whereby a pressurization transfer film according to claim 12 is used to partially provide an ink layer on a surface of a transfer target made of metal, after which an exposed metal part of the transfer target surface is decomposed to etch a metal surface.

20. A transfer target etching method whereby a pressurization transfer film according to claim 13 is used to partially provide an ink layer on a surface of a transfer target made of metal, after which an exposed metal part of the transfer target surface is decomposed to etch a metal surface.
